(19) United States
(12) Patent Application Publication
(10) Pub. No.: US 2024/0034416 A1
(43) Pub. Date: Feb. 1, 2024

(54) VEHICULAR ENGAGEMENT MEMBER

(71) Applicant: HONDA MOTOR CO., LTD., Tokyo (JP)

(72) Inventors: Naoki MINAMISAWA, Tokyo (JP); Takafumi MIKI, Tokyo (JP); Hideyuki YAMAGUCHI, Tokyo (JP)

(21) Appl. No.: 18/358,262

(22) Filed: Jul. 25, 2023

(30) Foreign Application Priority Data
Jul. 27, 2022 (JP) 2022-120032

(51) Int. Cl. B62D 27/02

(52) U.S. Cl. CPC B62D 27/02

(57) ABSTRACT

A vehicular engagement member for a vehicle is provided. The vehicular engagement member includes a base portion, and an engagement portion integrally molded with the base portion and engageable with a vehicle through an engagement claw portion. The base portion has a wall portion disposed opposite to the engagement claw portion and extending along an extension direction, in which the engagement portion extends. The wall portion has a space portion at a position opposite to the engagement claw portion, and the space portion is formed by an opening or a recess.

### CROSS-REFERENCE TO RELATED APPLICATION

This application claims the benefit of foreign priority to Japanese Patent Application No. 2022-120032, filed on Jul. 27, 2022, which is incorporated by reference in its entirety.

### TECHNICAL FIELD

The present invention relates to a member engaged with a vehicle (vehicular part) in a structure for connecting vehicular parts to each other.

### BACKGROUND

As a member engaged with a vehicular part, JP 2002-321570 A discloses a door trim, in which an engagement portion (engaged piece) engaged with a vehicular part is integrally molded.

If a vehicular engagement member has a wall portion in proximity to an engagement portion, the wall portion prevents a mold from being released. For this reason, the engagement portion is molded separately in advance and the engagement portion is assembled onto a main body of a vehicular engagement member.

In terms of productivity and product strength, it is desirable even for a vehicular engagement member having such a shape to be integrally molded with an engagement portion.

The present invention has been made in view of the above-described circumstances. An object of the present invention is to provide a vehicular engagement member, in which an engagement portion can be integrally molded.

### SUMMARY

To achieve the above object, an aspect of the present invention is to provide a vehicular engagement member for a vehicle comprising: a base portion; and an engagement portion integrally molded with the base portion and engageable with a vehicle through an engagement claw portion, wherein the base portion has a wall portion disposed opposite to the engagement claw portion and extending along an extension direction, in which the engagement portion extends, and the wall portion has a space portion at a position opposite to the engagement claw portion, the space portion being formed by an opening or a recess.

### BRIEF DESCRIPTION OF THE DRAWINGS

The drawings described herein are for illustration purposes only and are not intended to limit the scope of the present invention in any way.

FIG. 1 is a side view schematically showing a front part of a vehicle, to which is applied a vehicular part connecting structure using a vehicular engagement member according to one embodiment of the present invention.

FIG. 2 is a perspective view of the vehicular part connecting structure as viewed from outward in the vehicle width direction.

FIG. 3 is a perspective view of the vehicular part connecting structure as viewed from inward in the vehicle width direction.

FIG. 4 is a schematic view of the vehicular engagement member, as viewed from outward in the vehicle width direction.

FIG. 5 is a schematic view illustrating a wall portion and a third base portion of the vehicular engagement member, as viewed from inward in the vehicle width direction.

FIG. 6 is a perspective view schematically showing the wall portion and the third base portion of the vehicular engagement member.

FIG. 7 is a sectional view schematically showing the state in which the vehicular engagement member is engaged with a fender.

FIG. 8 is a sectional view schematically showing the state in which a pin is inserted into an engagement portion of the vehicular engagement member.

FIGS. 9A to 9C schematically explain a method of manufacturing a vehicular engagement member, in which FIG. 9A is a view illustrating the state in which plastic resin is injected into a space formed by a core mold, a cavity mold, and a slide mold, FIG. 9B is a view illustrating the release of the core mold and the cavity mold, and FIG. 9C is a view illustrating the release of the slide mold.

### DETAILED DESCRIPTION

With reference to the drawings, where appropriate, an embodiment of the present invention will be explained in detail by taking an example of connecting a bumper face and a left fender of a vehicle using a vehicular engagement member according to the present invention. Directions such as front and rear, right and left, and upper and lower refer to corresponding directions based on the vehicle and an occupant (driver) seated in the vehicle.

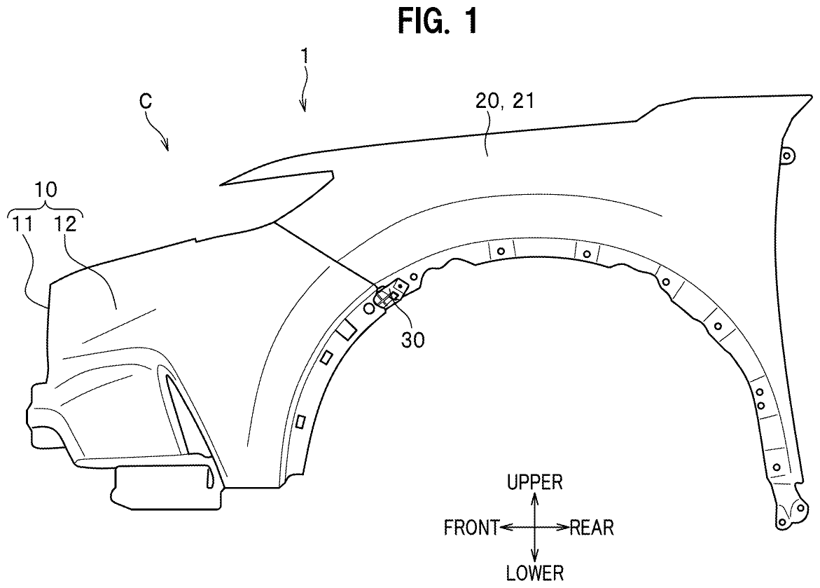

As seem in FIGS. 1 to 3, a vehicle C according to one embodiment of the present invention includes, as a vehicular member connecting structure 1, a bumper face 10, a fender and a vehicular engagement member 30. The vehicular member connecting structure 1 is a structure for connecting the bumper face 10 and the fender 20, which constitute the outer surface of the vehicle C as vehicular members, to each other by the vehicular engagement member 30.

### <Bumper Face>

The bumper face 10 is a plate member made of metal or plastic resin and constituting the outer surface of the front end part of the vehicle C. The bumper face 10 integrally includes a front wall portion 11 that constitutes the front surface of the vehicle C, a pair of side wall portions 12, 12 that extend rearward from both end portions of the front wall portion 11 in the vehicle width direction and constitute the side surfaces of the vehicle C, and rear wall portions 13, 13 that extend inward in the vehicle width direction from the rear end portions of the side wall portions 12, 12. The rear wall portion 13 is not formed at the lower end portion of the side wall portion 12.

### <Fender>

The fender 20 is a plate member made of metal or plastic resin and constituting the outer surface of a side end part of the vehicle C in the vehicle width direction, at the rear side of the bumper face 10. The fender 20 integrally includes a side wall portion 21 that constitutes the side surface of the vehicle C, a first front wall portion 22 that extends inward in the vehicle width direction from the front end portion of the side wall portion 21, an inner wall portion 23 that extends frontward from the inner end portion of the first front wall portion 22 in the vehicle width direction, and a second front wall portion 24 that extends inward in the vehicle width direction from the front end portion of the inner wall portion 23. The first front wall portion 22, the inner wall portion 23, and the second front wall portion 24 are not formed at the lower end portion of the side wall portion 21. The first front wall portion 22, the inner wall portion 23, and the lower end portion of the second front wall portion 24 are located above the lower end portion of the rear wall portion 13.

### <Vehicular Engagement Member>

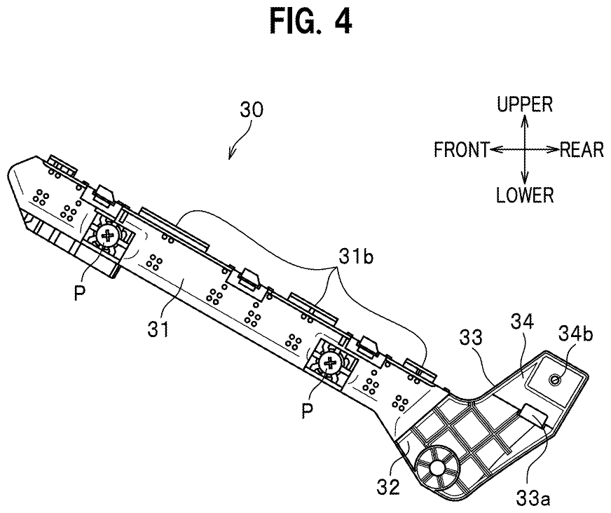

The vehicular engagement member 30 is an integrally molded member made of plastic resin and configured to connect the bumper face 10 and the fender 20 together. The vehicular engagement member 30 is a spacer interposed between the rear end portion of the side wall portion 12 of the bumper face 10 and the inner wall portion 23 of the fender 20. As seen in FIG. 4, the vehicular engagement member 30 integrally includes, as a base portion of the vehicular engagement member 30, a first base portion 31 that extends in the upper-lower direction, and a second base portion 32 that extends downward from the lower end portion of the first base portion 31. Further, the vehicular engagement member 30 integrally includes a wall portion 33 that extends outward in the vehicle width direction from the rear end portion of the second base portion 32, and a third base portion 34 that extends rearward from the outer end portion of the wall portion 33 in the vehicle width direction.

The first base portion 31 is provided at the inner side in the vehicle width direction of one of the side wall portion 12 of the bumper face 10 and the side wall portion 21 of the fender (in this embodiment, the first base portion 31 is provided at the side wall portion 12 of the bumper face 10). The third base portion 34 is provided at the outer side in the vehicle width direction of the other one of the side wall portion 12 of the bumper face 10 and the side wall portion 21 of the fender 20 (in this embodiment, the third base portion 34 is provided at the side wall portion 21 of the fender 20).

The first base portion (spacer portion) 31 is a main body portion, as a spacer, that is provided to fill the space formed by the rear end portion of the side wall portion 12 of the bumper face 10 and the first front wall portion 22 and the inner wall portion 23 of the fender 20. An engagement portion 31a (see FIG. 3) and grooves 31b are formed on the first base portion 31.

As seen in FIG. 3, the engagement portion 31a extends inward in the vehicle width direction from the first base portion 31. The engagement portion 31a is inserted into an opening 23a formed in the inner wall portion 23 of the fender 20 and is engaged with and fastened to the peripheral edge portion of the opening 23a. The rear wall portion 13 of the bumper face 10 is fitted into the grooves 31b.

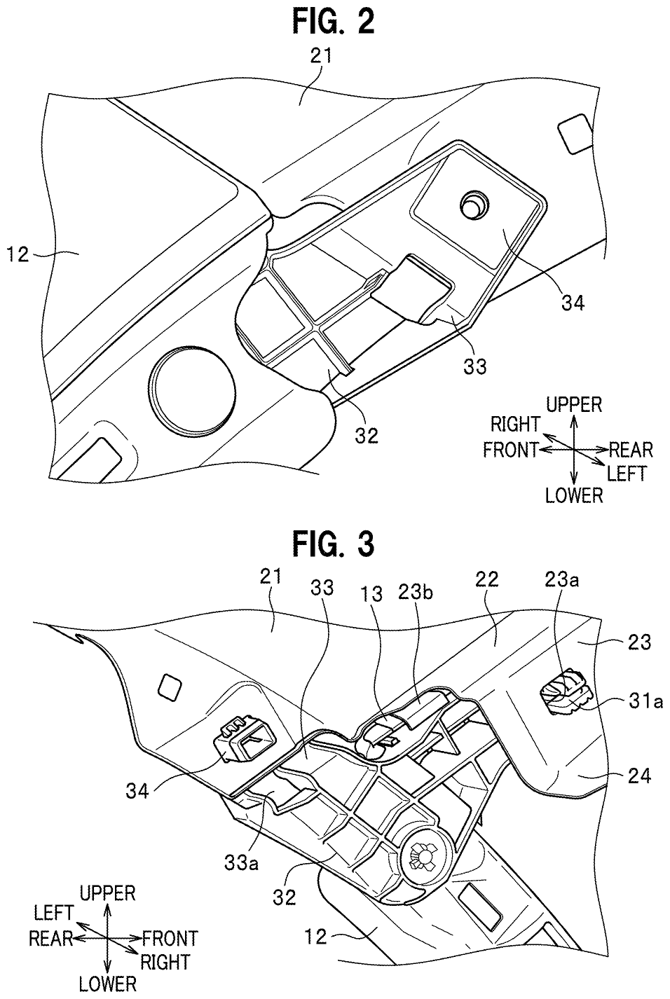

As seen in FIG. 2 and FIG. 4, the second base portion 32 is a plate member that is exposed downward from the space formed by the rear end portion of the side wall portion 12 of the bumper face 10 and the first front wall portion 22 and the inner wall portion 23 of the fender 20 and that is disposed inward in the vehicle width direction of the rear lower end portion of the side wall portion 12.

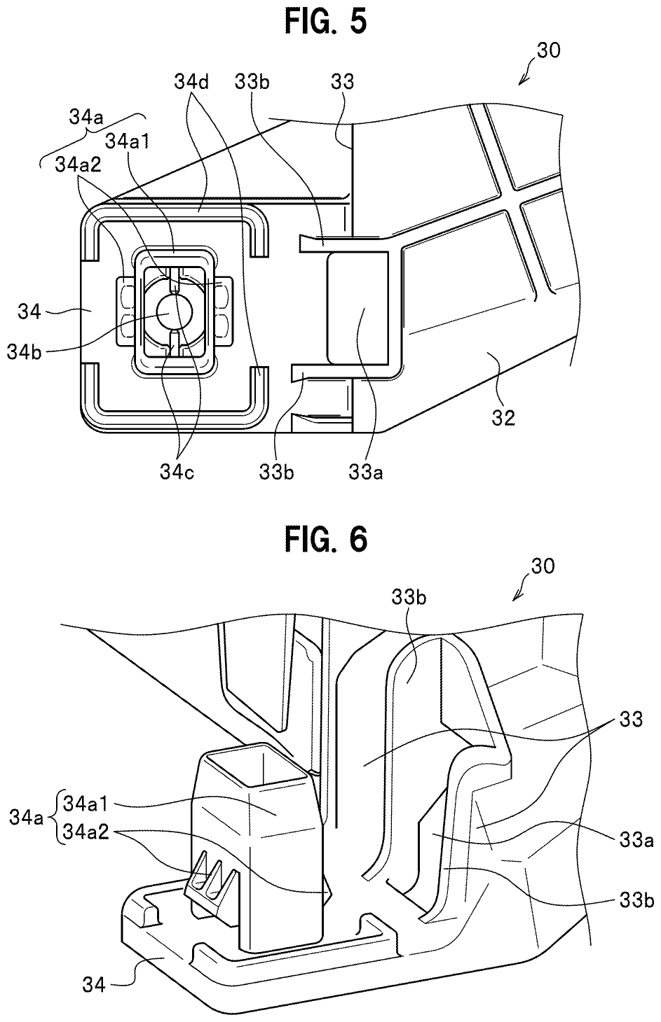

The wall portion 33 is a plate-like portion extending in the vehicle width direction (the same direction as an extension direction, in which an engagement portion 34a1 to be described later extends) in the gap formed between the rear lower end portion of the side wall portion 12 and the front lower end portion of the side wall portion 21. The wall portion 33 is a stepped portion configured to connect the first base portion 31, the second base portion 32, and the third base portion 34 in a stepwise (stepped) manner. As seen in FIG. 5 and FIG. 6, the wall portion 33 has an opening 33a and a pair of upper and lower flange portions 33b, 33b.

The opening 33a is provided at a position opposite to an engagement claw portion 34a2 of the engagement portion 34a to be described later. The opening 33a is an example of a space portion (e.g., opening or recess) to allocate a space from the engagement claw portion 34a2 with respect to the wall portion 33. According to this embodiment, the opening 33a is formed spanning from the wall portion 33 to the second base portion 32. The flange portion 33b extends rearward from the peripheral edge portion of the opening 33a.

The third base portion 34 is a plate-like portion disposed outward in the vehicle width direction at the front lower end portion of the side wall portion 21. The third base portion 34 has an engagement portion 34a, an opening 34b, first ribs 34c, and second ribs 34d.

The engagement portion 34a integrally includes a rectangular tube portion (shaft portion) 34a1 extending inward in the vehicle width direction (in the same direction as an extension direction, in which the wall portion 33 extends) from the third base portion 34, and engagement claw portions 34a2 protruding frontward and rearward from the proximal end sides of the front and rear wall portions of the rectangular tube portion 34a1. The engagement claw portions 34a2 are disposed spaced apart from the third base portion 34 and the both wall portions of the rectangular tube portion 34a1 that are arranged in the vehicle width direction.

The engagement claw portions 34a2 are configured to be elastically deformable in the front-rear direction. The engagement claw portion 34a2 formed on the front wall portion of the rectangular tube portion 34a1 protrudes frontward, and the engagement claw portion 34a2 formed on the rear wall portion of the rectangular tube portion 34a1 protrudes rearward.

The opening 34b is formed in the third base portion 34 at a portion surrounded by the rectangular tube portion 34a1.

The first ribs 34c are formed on the inner surface of the third base portion 34 in the vehicle width direction and extend toward the opening 34b from both wall portions of the rectangular tube portion 34a1 that are arranged in the vehicle width direction.

The second ribs 34d are formed on the inner surface of the third base portion 34 in the vehicle width direction and extend around the engagement portion 34a. As viewed from side, the second ribs 34d are not formed between the front engagement claw portion 34a2 and the wall portion 33, nor at the rear side of the rear engagement claw portion 34a2. In other words, the second ribs 34d are formed not to overlap with the region between the front engagement claw portion 34a2 and the wall portion 33 (i.e., no rib is formed in the region between the front engagement claw portion 34a2 and the wall portion 33).

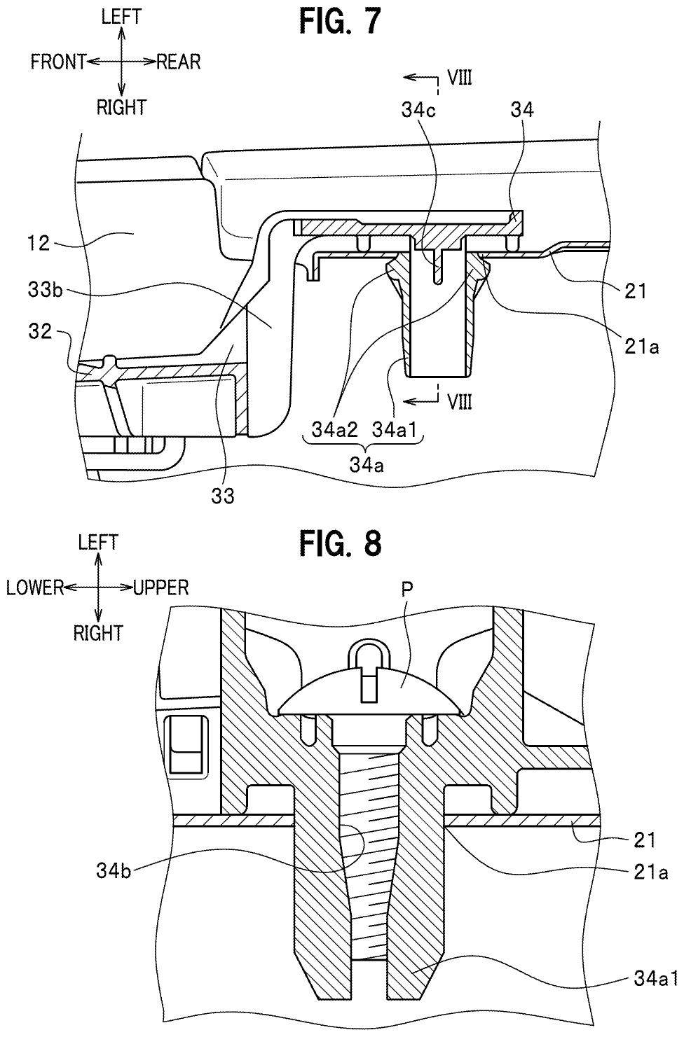

As seen in FIG. 7, the engagement claw portions 34a2 are inserted into an opening 21a formed in the side wall portion 21 of the fender 20 in a direction from outer side in the vehicle width direction toward the inner side in the vehicle width direction, and the engagement claw portions 34a2 are engaged with and secured to the peripheral edge portion of the opening 21a from the inner side in the vehicle width direction. Further, as seen in FIG. 8, a pin P is inserted into the opening 34b and positioned between the pair of engagement claw portions 34a2, 34a2. The pin P prevents elastic deformation of the engagement claw portions 34a2, 34a2 in a direction where the engagement claw portions 34a2, 34a2 come closer together, so that the pin restricts disengagement of the engagement portion 34a.

### <Method of Manufacturing Vehicular Engagement Member>

A method of manufacturing the vehicular engagement member 30 according to one embodiment of the present invention will be described with a specific focus on the manufacture around the third base portion 34 and the engagement portion 34a.

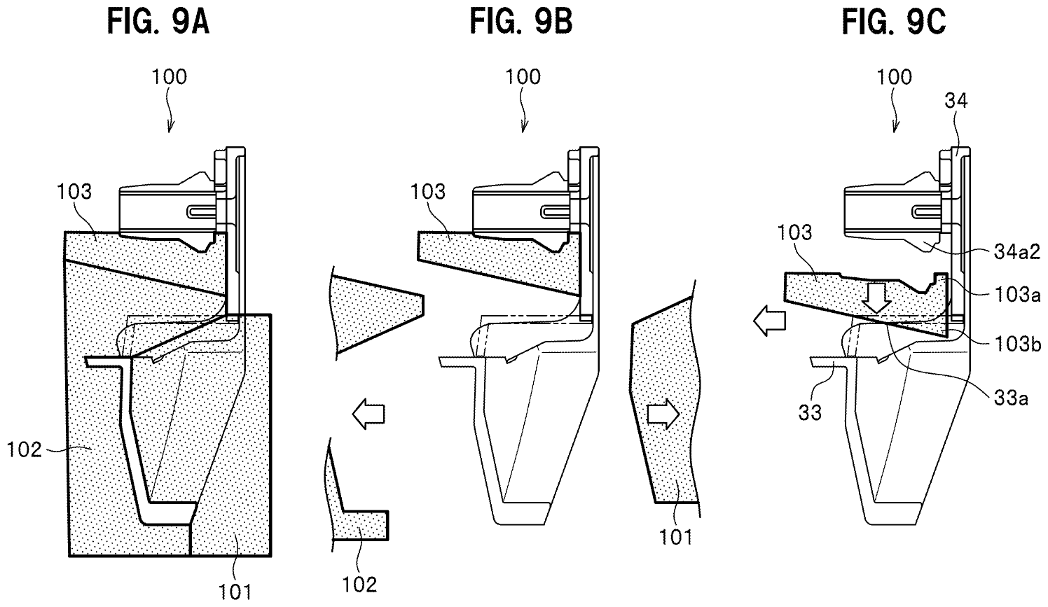

As seen in FIG. 9, a molding apparatus 100 according to one embodiment of the present invention is equipped with a core mold 101, a cavity mold 102, and a slide mold 103, as molds for manufacturing a vehicular engagement member 30. Molds other than the core mold 101, the cavity mold 102, and the slide mold 103 are not shown in the drawings and a description thereof will be omitted.

The core mold 101 is a mold having a protruding configuration to shape the outer surface of the third base portion 34 in the vehicle width direction. The cavity mold 102 is provided opposite to the core mold 101. The cavity mold 102 is a mold having a recessed configuration to shape the inner surface of the third base portion 34 in the vehicle width direction. The slide mold 103 is provided opposite to the core mold 101 and adjacent to the cavity mold 102. The slide mold 103 is a mold to shape the inner surface of the third base portion 34 in the vehicle width direction. The side surface of the slide mold 103 that is located on the cavity mold 102 side is inclined toward the cavity mold 102 as it approaches the core mold 101. Similarly, the side surface of the cavity mold 102 that is located on the slide mold 103 side is inclined toward the slide mold 103 as it is away from the core mold 101.

As seen in FIG. 9A, when the molding apparatus 100 equipped with the core mold 101, the cavity mold 102, and the slide mold 103 is closed, plastic resin is filled into the internal space formed by the core mold 101, the cavity mold 102, and the slide mold 103 to form a vehicular engagement member 30. The core mold 101 and the cavity mold 102 contact each other to form the opening 33a in the wall portion 33. The slide mold 103 forms the engagement claw portion 34a2 of the engagement portion 34a that is opposite to the wall portion 33.

Next, as seen in FIGS. 9B and 9C, the molding apparatus 100 equipped with the core mold 101, the cavity mold 102, and the slide mold 103 is opened to remove the vehicular engagement member 30. First, as seen in FIG. 9B, the core mold 101 and the cavity mold 102 move in a direction away from the vehicular engagement member 30. Then, as seen in FIG. 9C, the slide mold 103 slides in a direction away from the engagement claw portion 34a2, i.e., in a direction approaching the wall portion 33. This is because if the slide mold 103 moves directly in a direction away from the vehicular engagement member 30, a portion 103a that shapes the engagement claw portion 34a2 is brought into contact with the engagement claw portion 34a2 and thus prevents such movement of the slide mold 103. For this reason, the slide mold 103 having the inclined configuration as described above slides such that the portion 103b that is inclined and protrudes at a position opposite to the portion 103a passes through the opening 33a.

The slide mold 103 then moves in the direction away from the vehicular engagement member 30. According to this embodiment, the opening 33a is formed to extend to the second base portion 32. With this configuration, the slide mold 103 can move smoothly in the mold release direction.

As described previously, the slide mold 103 can slide (and move in the mold release direction) such that the portion 103b that is inclined and protrudes at a position opposite to the portion 103a passes through the opening 33a. This makes it possible to ensure the thickness and obtain sufficient mold strength even if the distance between the engagement claw portion 34a2 and the wall portion 33 is narrow. Since the vehicular engagement member 30 includes the wall portion 33 having the opening 33a, it is possible to integrally mold the engagement claw portion 34a2 at a position opposite to the wall portion 33 and to improve the degree of design freedom of the distance between the engagement portion 34a and the wall portion 33.

The vehicular engagement member 30 according to one embodiment of the present invention includes the base portion (third base portion 34), and the engagement portion 34a integrally molded with the base portion and engageable with the vehicle C through the engagement claw portions 34a2. In this vehicular engagement member 30, the base portion has the wall portion 33 disposed opposite to the engagement claw portion 34a2 and extending along the extension direction, in which the engagement portion 34a extends, and the wall portion 33 has the space portion at a position opposite to the engagement claw portion 34a2. The space portion is formed by the opening 33a or a recess.

With this configuration of the vehicular engagement member 30, the slide mold 103 for forming the engagement claw portion 34a2 can be opened or removed by utilizing the space portion. This makes it possible to integrally mold the engagement portion 34a and to improve the degree of design freedom of the engagement portion 34a.

Further, the vehicular engagement member 30 is configured such that the wall portion 33 has the flange portions 33b formed at the edge portion of the space portion.

This configuration of the vehicular engagement member 30 makes it possible to suppress a decrease in strength caused by the presence of the space portion.

Further, the vehicular engagement member 30 is configured such that the base portion has the ribs (second ribs 34d) formed around the engagement portion 34a and that the ribs are formed not to overlap with the region between the engagement portion 34a and the space portion.

This configuration of the vehicular engagement member 30 makes it possible to improve the strength of the base portion (third base portion 34) without interfering with the release of the slide mold 103.

Further, the vehicular engagement member 30 is configured such that the base portion includes: the spacer portion (first base portion 31) disposed inward in the vehicle width direction of one of the bumper face 10 and the fender 20 of the vehicle C; the portion (third base portion 34) disposed outward in the vehicle width direction of the other one of the bumper face 10 and the fender 20, and to which the engagement portion 34a is integrally molded; and the wall portion 33 connecting the spacer portion and the portion to which the engagement portion is integrally molded.

This configuration of the vehicular engagement member 30 makes it possible to integrally mold the engagement portion 34a in proximity to the wall portion 33 for connecting the bumper face 10 and the fender 20 in the vehicle width direction, while ensuring that the presence of the wall portion 33 does not affect the molding process.

Although embodiments of the present invention have been described above, the present invention is not limited to the above-described embodiments. Various changes and modifications may be made where appropriate without departing from the gist of the present invention. For example, the vehicular engagement member 30 is not limited to a member for connecting the bumper face 10 and the fender 20 together, but may be a member to be engaged with another vehicular member. Further, the space portion formed in the wall portion 33 may be a recess that is recessed in a direction away from the engagement claw portion 34a2.

What is claimed is:

1. A vehicular engagement member for a vehicle comprising:
a base portion; and
an engagement portion integrally molded with the base portion and engageable with a vehicle through an engagement claw portion, wherein
the base portion has a wall portion disposed opposite to the engagement claw portion and extending along an extension direction, in which the engagement portion extends, and
the wall portion has a space portion at a position opposite to the engagement claw portion, the space portion being formed by an opening or a recess.

2. The vehicular engagement member according to claim 1, wherein the wall portion has a flange portion formed at an edge portion of the space portion.

3. The vehicular engagement member according to claim 1, wherein
the base portion has a rib formed around the engagement portion, and
the rib is formed not to overlap with a region between the engagement portion and the space portion.

4. The vehicular engagement member according to claim 1, wherein
the base portion comprises:
a spacer portion disposed inward in a vehicle width direction of one of a bumper face and a fender of the vehicle;
a portion disposed outward in the vehicle width direction of the other one of the bumper face and the fender, and to which the engagement portion is integrally molded; and
the wall portion connecting the spacer portion and the portion to which the engagement portion is integrally molded.
